(19) United States
(12) Patent Application Publication
(10) Pub. No.: US 2022/0340076 A1
(43) Pub. Date: Oct. 27, 2022

(54) VEHICLE CONTROL SYSTEM AND METHOD FOR USING RECOGNITION OF STATE OF DRIVER

(71) Applicant: HYUNDAI MOBIS CO., LTD., Seoul (KR)

(72) Inventors: Hyun Jun LIM, Uiwang-si (KR); Yeon Su KIM, Gunpo-si (KR)

(73) Assignee: HYUNDAI MOBIS CO., LTD., Seoul (KR)

(21) Appl. No.: 17/726,752

(22) Filed: Apr. 22, 2022

(30) Foreign Application Priority Data
Apr. 23, 2021 (KR) 10-2021-0053084
Apr. 26, 2021 (KR) 10-2021-0053609

(51) Int. Cl. B60Q 1/34; B60W 50/10; B60W 30/18; G06V 20/59; H04W 4/46

(52) U.S. Cl. CPC B60Q 1/346; B60W 50/10; B60W 30/18163; G06V 20/597; H04W 4/46; B60W 2420/42; B60W 2540/18; B60W 2540/225; B60W 2556/65

(57) ABSTRACT

The present invention determines whether a vehicle is traveling at a location where preparation is needed for the vehicle to exit to another road branching from a current traveling road, estimates a lane change intention of a driver when it is determined that a lane change is needed for the vehicle to exit the current traveling road, and communicates the lane change to neighboring vehicles by activating a turn signal when the lane change intention is estimated.

### CROSS-REFERENCE TO RELATED APPLICATIONS

The present application claims priority to Korean Patent Application Nos. 10-2021-0053084, filed Apr. 23, 2021, and 10-2021-0053609, filed on Apr. 26, 2021, the entire contents of which is incorporated herein for all purposes by this reference.

### BACKGROUND

### 1. Technical Field

The present invention relates to a technology for predicting the behavior of a vehicle and controlling the vehicle based thereon using a state of a driver driving the vehicle.

### 2. Discussion of Related Art

There is a high risk of a traffic accident when a vehicle suddenly cuts in an adjacent lane without turning on a turn signal on a road where vehicles are traveling.

A failure to activate a turn signal even in a situation that warrants the activation of the turn signal, a sudden lane change, and the like tend to happen frequently on the road due to various factors such as a disposition, driving experience, psychological state, and the like of the drivers and serve as major contributors to increased travel risk. However, no adequate countermeasures are taken at a vehicle level.

The matters described above as a technical background are intended only for a better understanding of the background of the present invention and are not to be taken as acknowledgment that they pertain to the conventional art already known to those skilled in the art.

### SUMMARY

An object of the present invention is to provide a vehicle control system and method for using recognition of a state of a driver to substantially reduce the possibility of a traffic accident by detecting an intention of the driver to change lanes to an adjacent lane from the state of the driver even when the driver performs a lane change without activating a turn signal when changing lanes to exit the current traveling road to the right or left and communicating the lane change intention to neighboring vehicles.

Further, another object of the present invention is to provide a vehicle control system and method for using recognition of a state of a driver to substantially reduce the possibility of a traffic accident by automatically predicting a cut-in situation by recognizing the state of the driver in a situation where the driver suddenly cuts in an adjacent lane without activating a turn signal and warning the vehicles in the adjacent lane to recognize as quickly as possible, and prepare for, the cut-in situation.

According to the present invention, a vehicle control system for utilizing recognition of the state of the driver for achieving the object described above includes a route prediction device setting an expected traveling route of the vehicle and determining whether the vehicle is traveling at a location where preparation is needed for the vehicle to exit to another road branching from a current traveling road; a need-for-change check unit checking whether a lane change is needed for the vehicle to exit when it is determined that the vehicle is traveling at a location where preparation is needed for the vehicle to exit the current traveling road; a lamp activation determination unit determining whether a turn signal is activated for a lane change when it is determined that the lane change is needed for the vehicle to exit the current traveling road; a monitoring camera provided in the vehicle to recognize a direction of a gaze of the driver; a steering angle sensor sensing a steering manipulation by the driver; an intention estimation unit estimating a lane change intention of the driver based on the direction information of the gaze of the driver obtained by the monitoring camera and the steering manipulation information obtained by the steering angle sensor; and a control unit communicating a lane change intention to the neighboring vehicles by activating a turn signal when the intention estimation unit estimates a lane change intention of the driver in a state where the lamp activation determination unit determines that the turn signal is not activated for the lane change.

The route prediction device may determine that the vehicle is traveling at a location where preparation is needed for the vehicle to exit to another road when a distance from the current traveling road to the position where the other road to exit to starts to branch from the current traveling road is within a predetermined reference distance.

The intention estimation unit may determine that the driver intends to change lanes when the steering angle by the driver obtained by the steering angle sensor is equal to or greater than a predetermined reference angle from the neutral state and the time in which the gaze of the driver obtained by the monitoring camera remains directed toward a side-view mirror or a side window is equal to or greater than a predetermined reference time.

The control unit may communicate the lane change intention of the driver to the neighboring vehicles using a V2V communication device mounted in the vehicle when it is estimated that the driver intends to change lanes in a state where the turn signal is not activated for the lane change.

The control unit may communicate the lane change intention of the driver to other neighboring V2X communication devices using a V2X communication device mounted in the vehicle when it is estimated that the driver intends to change lanes in a state where the turn signal is not activated for the lane change.

The control unit may communicate the lane change intention of the driver to the neighboring vehicles using the V2V communication device mounted in the vehicle when the lamp activation determination unit determines that the turn signal is activated for the lane change.

The control unit may communicate the lane change intention of the driver to other neighboring V2X communication devices using the V2X communication device mounted in the vehicle when the lamp activation determination unit determines that the turn signal is activated for the lane change.

Further, a vehicle control method for using recognition of a state of a driver according to the present invention includes determining whether the vehicle is traveling at a location where preparation is needed for the vehicle to exit to another road branching from a current traveling road; determining whether a lane change is needed for the vehicle to exit to the other road; determining whether a turn signal is activated for the lane change; estimating a lane change intention of the driver based on a steering angle and a gaze of the driver when it is determined that the turn signal is not activated; and communicating the lane change intention to neighboring vehicles by activating the turn signal when it is estimated that the driver intends to change lanes in a state where the turn signal is not activated for the lane change.

When a distance from the current vehicle position on the current traveling road to the position where the other road for the vehicle to exit to starts to branch from the current traveling road is within a predetermined reference distance, it may be determined that the vehicle is traveling at a location where preparation is needed for the vehicle to exit to the other road.

When the steering angle by the driver is equal to or greater than a predetermined reference angle from the neutral state and the time in which the gaze of the driver remains directed toward the side-view mirror or the side window is equal to or greater than a predetermined reference time or more, it may be determined that the driver intends to change lanes.

When it is estimated that the driver intends to change lanes in a state where the turn signal is not activated for the lane change, the lane change intention of the driver may be communicated to the neighboring vehicle using the V2V communication device mounted in the vehicle in addition to activating the turn signal.

When it is estimated that the driver intends to change lanes in a state where the turn signal is not activated for the lane change, the lane change intention of the driver may be communicated to the neighboring vehicle using the V2X communication device mounted in the vehicle in addition to activating the turn signal.

When the turn signal is activated for the lane change in a state where the lane change is needed for the vehicle to exit to the other road, the lane change intention of the driver may be communicated to the neighboring vehicles using the V2V communication device mounted in the vehicle.

When the turn signal is activated for the lane change in a state where the lane change is needed for the vehicle to exit to the other road, the lane change intention of the driver may be communicated to other neighboring V2X communication devices using the V2X communication device mounted in the vehicle.

Further, a vehicle control system for using recognition of a state of a driver according to the present invention includes a monitoring camera provided in a vehicle to recognize the direction of the gaze of the driver; a steering angle sensor sensing the steering manipulation by the driver; an intention estimation unit estimating an intention of the driver to cut in an adjacent lane based on the direction information of the gaze of the driver obtained by the monitoring camera and the steering manipulation information obtained by the steering angle sensor; and a communication tool for communicating the information on the cut-in intention when the intention estimation unit estimates that the driver intends to cut in an adjacent lane.

The intention estimation unit may determine that the driver intends to cut in an adjacent lane when the steering angle by the driver obtained by the steering angle sensor is equal to or greater than a predetermined reference angle and the time in which the gaze of the driver obtained by the monitoring camera remains directed toward the side-view mirror or the side window is equal to or greater than a predetermined reference time.

The communication tool may include a turn signal of the vehicle to warn the neighboring vehicles of the cut-in situation by activating the turn signal when the intention estimation unit estimates that the driver intends to cut in an adjacent lane.

The communication tool may include a V2V communication device to communicate the cut-in situation to the neighboring vehicles through the V2V communication device when the intention estimation unit estimates that the driver intends to cut in an adjacent lane.

The present invention may substantially reduce the possibility of a traffic accident by detecting an intention to change lanes to an adjacent lane from the state of the driver and communicating the lane change intention to the neighboring vehicles even when the driver performs the lane change without activating the turn signal when changing lanes from the current traveling road to the right or left.

Further, the present invention may substantially reduce the possibility of a traffic accident by automatically predicting a cut-in situation by recognizing the state of the driver in a situation where the driver suddenly cuts in an adjacent lane without activating the turn signal so that the neighboring vehicles in the adjacent lane may quickly recognize, and prepare for, the cut-in situation.

### BRIEF DESCRIPTION OF THE DRAWINGS

FIG. 1 is a block diagram illustrating a first embodiment of a vehicle control system for using recognition of a state of a driver according to the present invention.

FIG. 2 is a view illustrating an example of a monitoring camera installed in a vehicle.

FIG. 3 is a view illustrating a location where preparation is needed for a vehicle to exit to another road branching from a current traveling road.

FIG. 4 is a flowchart illustrating a first embodiment of a vehicle control system for using recognition of a state of a driver according to the present embodiment.

FIG. 5 is a block diagram illustrating a second embodiment of a vehicle control system for using recognition of a state of a driver according to the present invention.

FIG. 6 is a flowchart illustrating a second embodiment of a vehicle control system for using recognition of a state of a driver according to the present embodiment.

### DETAILED DESCRIPTION

The specific structural or functional descriptions of the embodiments disclosed in the present specification or application are merely exemplified for the purpose of describing the embodiments according to the present invention. The embodiments of the present invention may be implemented in various forms, and the present invention is not to be interpreted as being limited to the embodiments described in the present specification or application.

The embodiment according to the present invention may be subject to various modifications and have various forms so that specific embodiments will be illustrated in the drawings and described in detail in the present specification or application. It is to be understood that this is not intended to limit the embodiments according to the concept of the present invention to the specific disclosed forms and that all modifications, equivalents, and substitutes within the spirit and technical scope of the present invention are included.

terms such as first, second, etc. may be used to describe various components, but the components are not to be limited by the terms. The terms may only be used for the purpose of distinguishing one component from another. For example, without departing from the scope of the present invention, a first component may be denoted as a second component, and similarly, a second component may also be denoted as a first component.

When a component is referred to as being “connected” or “coupled” to another component, the component may be directly connected or coupled to the other component, but it is to be understood that other components may exist in between. On the other hand, when a component is referred to as being “directly connected” or “directly coupled” to another component, it is to be understood that there are no intervening components present. Other expressions describing a relationship between components, that is, “between,” “just between,” “neighboring,” and “directly neighboring” are to be interpreted in the same manner.

The terms used herein are used for the purpose of describing specific embodiments only and are not intended to limit the invention. Singular expressions may include plural expressions unless the context explicitly indicates otherwise. It is to be understood that the terms such as “comprise” or “have” are intended to point out the presence of features, numbers, steps, operations, components, parts, or combinations thereof disclosed in the specification and that the presence or additional possibilities of one or more of other features, numbers, steps, operations, components, parts or combinations thereof are not precluded in advance.

Unless otherwise defined, all terms used herein, including technical or scientific terms, may have the same meanings as are generally understood by those skilled in the art to which the present invention pertains. The terms such as those defined in commonly used dictionaries are to be interpreted as having meanings consistent with their meanings in the context of the related technology and are not to be interpreted in an idealized or overly formal sense unless expressly so defined herein.

Hereinafter, the present invention will be described in detail by describing the preferred embodiments of the present invention with reference to the accompanying drawings. The same reference numerals presented in each drawing refer to the same members.

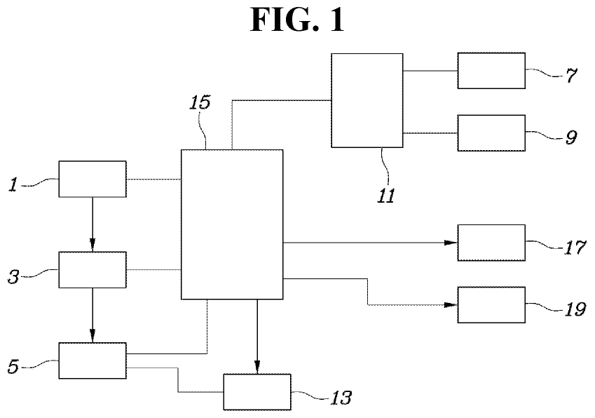

FIGS. 1 to 3 show that a first embodiment of a vehicle control system for using recognition of a state of a driver according to the present invention includes a route prediction device 1 setting an expected traveling route of the vehicle and determining whether the vehicle is traveling at an exit preparation area where a preparation is needed for the vehicle to exit to another road branching from a current traveling road; a need-for-change check unit 3 determining whether a lane change is needed for the vehicle to exit when it is determined that the vehicle is traveling at the exit preparation area; a lamp activation determination unit 5 determining whether a turn signal 13 is activated for a lane change when it is determined that the lane change is needed for the vehicle to exit the current traveling road; a monitoring camera 7 provided in a vehicle to recognize a direction of a gaze of the driver; a steering angle sensor 9 sensing a steering manipulation by the driver; an intention estimation unit 11 estimating a lane change intention of the driver based on direction information of the gaze of the driver obtained by the monitoring camera 7 and steering manipulation information obtained by the steering angle sensor 9; and a control unit 15 communicating the lane change intention to neighboring vehicles by activating a turn signal 13 when the intention estimation unit 11 estimates the lane change intention of the driver in a state where the lamps activation determination unit 5 determines that the turn signal 13 is not activated for the lane change.

The route prediction device 1 may include a navigator and the like.

That is, according to the present invention, when a vehicle needs to exit to another road branching from the current traveling road either to the right or left in order to follow a route to a destination set by the route prediction unit 1 while traveling on a road having two or more lanes, and when it is estimated that the driver intends to change lanes in a state where the lane change is needed to exit the current traveling road but the turn signal 13 is not activated, the control unit 15 communicates the lane change situation to neighboring vehicles by activating the turn signal 13, so that a traffic accident caused by an unexpected lane change of the vehicle may be prevented.

The route prediction device 1 may determine that the vehicle is traveling at the exit preparation area when the distance from the current vehicle position to a position where the other road to exit to starts to branch from the current traveling road is within a predetermined reference distance.

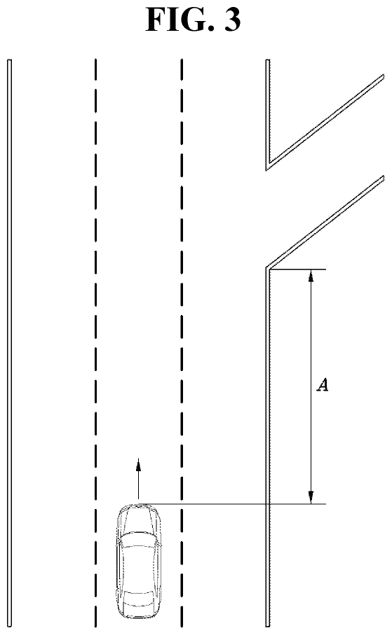

For example, as illustrated in FIG. 3, when the reference distance is set to 300 m and the distance A to the position where another road to exit to branches from the current traveling road is equal to or less than 300 m, it is determined that the vehicle is traveling at the exit preparation area.

The intention estimation unit 11 may determine that the driver intends to change lanes when the steering angle by the driver obtained by the steering angle sensor 9 is equal to or greater than a predetermined reference angle.

That is, since the fact that the driver manipulates the steering wheel to or beyond the reference angle may be viewed as a direct indication that the driver intends to change lanes to an adjacent lane, the lane change intention of the driver may be estimated by monitoring such a change of the steering angle.

Accordingly, the reference angle is preferably set to a level that allows checking of the lane change intention of the driver to some extent in accordance with the intent described above and may be set through a plurality of experiments and interpretations. The reference angle may be set to 30°, for example.

The intention estimation unit 11 may determine that the driver intends to change lanes when the time in which the gaze of the driver obtained by the monitoring camera 7 remains directed toward a side-view mirror or a side window is equal to or greater than a predetermined reference time.

That is, since the driver generally gazes in the direction to change lanes when the driver intends to change lanes to an adjacent lane, it may be determined that the driver intends to change lanes to the adjacent lane when the driver gazes toward the side-view mirror or the side window of the vehicle for the reference time or more during the continued monitoring of the gaze of the driver by the monitoring camera 7.

Accordingly, the reference time may be set to a level that allows an expectation of the lane change by the driver to some extent in accordance with the intent described above and may be set through a plurality of experiments and interpretations. The reference time may be set to two seconds, for example.

Further, since the driver may alternately look forward and toward the side-view mirror instead of continuously keeping the gaze toward the side-view mirror even when the driver intends to change lanes to an adjacent lane, it may also be determined that the driver intends to change lanes to an adjacent lane when the driver repeatedly gazes toward the side-view mirror or the side window within a short time like a few seconds.

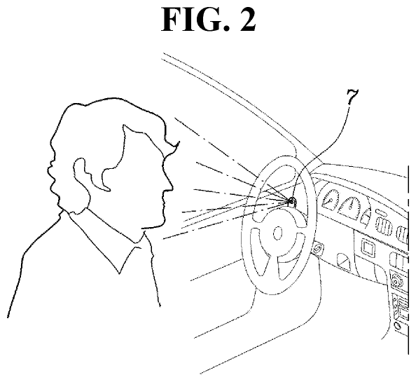

It is to be noted that, as illustrated in FIG. 2, the monitoring camera 7 may be installed at a position where the eyes of the driver may be photographed to monitor and analyze the direction that the eyes of the driver face.

The monitoring camera 7 may be installed at any position, other than the position illustrated in FIG. 2, inside the vehicle as long as the direction that the eyes of the driver face may be recognized.

The intention estimation unit 11 may determine that the driver intends to change lanes when the steering angle by the driver obtained by the steering angle sensor 9 is equal to or greater than a predetermined reference angle and the time in which the gaze of the driver obtained by the monitoring camera 7 remains directed toward the side-view mirror or the side window is equal or greater than a predetermined reference time.

That is, when it is estimated that the driver intends to change lanes to an adjacent lane based on the steering angle estimation and the direction estimation of the gaze of the driver, it is determined that the driver actually intends to change lanes to the adjacent lane, so that the reliability of the system may be improved through a more reliable estimation of the intention of the driver.

The control unit 15 may communicate the lane change intention of the driver to the neighboring vehicles using a V2V communication device 17 when it is estimated that the driver intends to change lanes in a state where the turn signal 13 is not activated for the lane change.

That is, the control unit 15 may more reliably communicate the lane change intention of the driver to the neighboring vehicles using the vehicle-to-vehicle V2V communication device 17 mounted in the vehicle in addition to activating the turn signal 13 when it is estimated that the driver intends to change lanes in a state where the turn signal 13 is not activated for the lane change.

Of course, the V2V communication devices of the neighboring vehicles receiving the information transmitted from the V2V communication device 17 may be connected to at least one, or more, of various information devices such as a display device, a lamp, a buzzer, a voice guide device, and the like to deliver the received information to the drivers so that the received information may be communicated to the drivers.

Accordingly, when the turn signal 13 blinks in the vehicle of the driver who intends to change lanes and the information on the lane change intention is communicated to the neighboring vehicles through the V2V communication device 17, the neighboring vehicles may recognize the lane change intention and may more effectively prepare for the lane change of the vehicle, so that the possibility of an accident is reduced.

The control unit 15 may communicate the lane change intention of the driver to other neighboring vehicle-to-everything V2X communication devices using a V2X communication device 19 mounted in the vehicle when it is estimated that the driver intends to change lanes in a state where the turn signal 13 is not activated for the lane change.

That is, the control unit 15 creates a safer traffic condition by communicating the lane change intention of the driver under the circumstances described above to all the targets, such as traffic infrastructure networks, pedestrians as well as neighboring vehicles, that may use the relevant information for each target to be properly prepared using the information.

It is to be noted that the V2X communication device 19 conceptually includes the V2V communication device 17, but FIG. 1 illustrates each as a separate component.

On the other hand, even when the lamp activation determination unit 15 determines that the turn signal 13 is activated for the lane change, the control unit may communicate the lane change intention of the driver to the neighboring vehicles or other V2X communication devices 19 using the V2V communication device 17 or the V2X communication device 19 mounted in the vehicle, so that creating a safer traffic condition may be created.

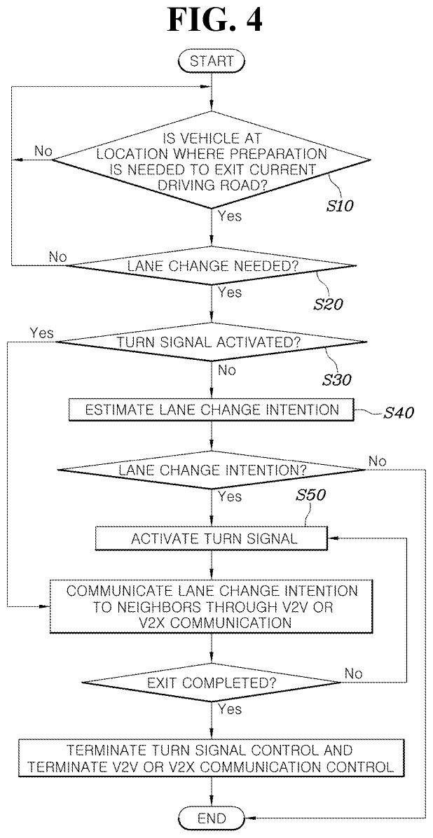

FIG. 4 shows that a first embodiment of a vehicle control method for using recognition of a state of a driver according to the present invention includes determining whether the vehicle is traveling at the exit preparation area where a preparation is needed for the vehicle to exit to another road branching from a current traveling road (S10); determining whether a lane change is needed for the vehicle to exit to the other road (S20); determining whether a turn signal 13 is activated for the lane change (S30); estimating a lane change intention of a driver based on a steering angle and a gaze of the driver when it is determined that a turn signal 13 is not activated (S40); and communicating the lane change intention to neighboring vehicles by activating the turn signal 13 when it is estimated that the driver intends to change lanes in a state where the turn signal 13 is not activated for the lane change (S50).

When the distance from the current vehicle position on the current traveling road to a position where the other road for the vehicle to exit to starts to branch from the current traveling road is within a predetermined reference distance, it may be determined that the vehicle is traveling at the exit preparation area.

When the steering angle by the driver obtained by the steering angle sensor 9 is equal to or greater than a reference angle from the neutral state, it may be determined that the driver intends to change lanes.

When the time in which the gaze of the driver obtained by the monitoring camera 7 remains directed toward the side-view mirror or the side window is equal to or greater than the reference time, it may be determined that the driver intends to change lanes.

When the steering angle by the driver obtained by the steering angle sensor 9 is equal to or greater than a predetermined reference angle from the neutral state and the time in which the gaze of the driver obtained by the monitoring camera 7 remains directed toward the side-view mirror or the side window is equal to or greater than a predetermined reference time, it may be determined that the driver intends to change lanes.

When it is estimated that the driver intends to change lanes in a state where the turn signal 13 is not activated for the lane change, the lane change intention of the driver may be communicated to the neighboring vehicles using the V2V communication device 17 in addition to activating the turn signal 13.

When it is estimated that the driver intends to change lanes in a state where the turn signal 13 is not activated for the lane change, the lane change intention of the driver may be communicated to the neighboring vehicles using the V2X communication device 19 in addition to activating the turn signal 13.

Even when the turn signal 13 is activated for the lane change in a state where the lane change is needed for the vehicle to exit to the other vehicle, the lane change intention of the driver may be communicated to the neighboring vehicles using the V2V communication device 17 mounted in the vehicle.

Even when the turn signal 13 is activated for the lane change in a state where the lane change is needed for the vehicle to exit to the other vehicle, the lane change intention of the driver may be communicated to other neighboring V2X communication devices using the V2X communication device 19 mounted in the vehicle.

Of course, when the exit to the road is terminated, the control unit 15 terminates the control of the turn signal 13 and terminates the control of the V2V communication device 17 or the V2X communication device 19.

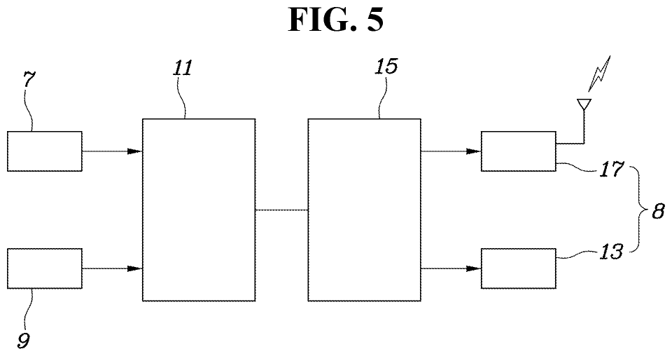

FIG. 5 shows that a second embodiment of the vehicle control system for using recognition of the state of the driver includes a monitoring camera 7 provided in the vehicle to recognize the direction of the gaze of a driver; a steering angle sensor 9 sensing steering manipulation by the driver; an intention estimation unit 11 estimating a cut-in intention of the driver to an adjacent lane based on direction information of the gaze of the driver obtained by the monitoring camera 7 and the steering manipulation information obtained by the steering angle sensor 9; and a communication tool 8 for communicating the information on the cut-in intention to neighboring vehicles when the intention estimation unit 11 estimates that the driver intends to cut in an adjacent lane.

That is, the present invention may reduce the risk of a traffic accident by determining whether the driver intends to cut in an adjacent lane based on the steering angle information obtained by the steering angle sensor 9 provided in the vehicle to measure the steering angle according to the steering manipulation and the direction information of the gaze of the driver obtained by the monitoring camera 7 provided in the vehicle to sense the gaze of the driver, and communicating the information to the neighboring vehicles when the cut-in intention of the driver is expected so that the vehicles may be prepared.

As illustrated in FIG. 2, the monitoring camera 7 is installed at a position where the eyes of the driver may be photographed to monitor and analyze the direction that the eyes of the driver face.

The monitoring camera 7 may be installed at any position other than the position illustrated in FIG. 2 as long as the direction that the eyes of the driver face may be recognized.

The intention estimation unit 11 may determine that the driver intends to cut in an adjacent lane when the steering angle by the driver obtained by the steering angle sensor 9 is equal to or greater than a predetermined reference angle.

That is, since the fact that the driver manipulates the steering wheel to or beyond the reference angle may be viewed as a direct indication that the driver intends to cut in an adjacent lane, the intention of the driver to cut in an adjacent lane may be estimated by monitoring the change of the steering angle.

Accordingly, the reference angle is preferably set to a level that allows checking of the cut-in intention of the driver to some extent in accordance with the intent described above and may be set through a plurality of experiments and interpretations. The reference angle may be set to 30°, for example.

The intention estimation unit 11 may determine that the driver intends to cut in an adjacent lane when the time in which the gaze of the driver obtained by the monitoring camera 7 remains directed toward the side-view mirror or the side window is equal to or greater than a predetermined reference time.

That is, since the driver generally gazes in the direction to change lanes when the driver intends to change lanes to an adjacent lane, it may be determined that the driver intends to change lanes to the adjacent lane when the driver gazes toward the side-view mirror or the side window of the vehicle for the reference time or more during the continued monitoring of the gaze of the driver by the monitoring camera 7.

Accordingly, the reference time may be set to a level that allows an expectation of the cut-in by the driver to some extent in accordance with the intent described above and may be set through a plurality of experiments and interpretations. The reference time may be set to two seconds, for example.

Further, since the driver may alternately look forward and toward the side-view mirror instead of continuously keeping the gaze toward the side-view mirror even when the driver intends to cut in an adjacent lane, it may also be determined that the driver intends to cut in an adjacent lane when the driver repeatedly gazes toward the side-view mirror or the side window within a short time like a few seconds.

When the steering angle by the driver obtained by the steering angle sensor 9 is equal to or greater than a predetermined reference angle from the neutral state and the time in which the gaze of the driver obtained by the monitoring camera 7 remains directed toward the side-view mirror or the side window is equal to or greater than a predetermined reference time, the intention estimation unit 11 may determine that the driver intends to cut in an adjacent lane.

That is, when it is estimated that the driver intends to change lanes to an adjacent lane based on both the steering angle estimation and the direction estimation of the gaze of the driver, it is determined that the driver actually intends to change lanes to the adjacent lane, so that the reliability of the system may be improved through a more reliable estimation of the intention of the driver.

The communication tool 8 may include a turn signal 13 of the vehicle to warn the neighboring vehicles of the cut-in situation by activating the turn signal 13 when the intention estimation unit 11 estimates that the driver intends to cut in an adjacent lane.

That is, upon receiving the information that the driver intends to cut in an adjacent lane from the intention estimation unit 11, the control unit 13 in FIG. 5 activates the turn signal 13 so that the neighboring vehicles may recognize the cut-in intention.

Further, the communication tool 8 may include the vehicle-to-vehicle communication device V2V 17 to communicate the cut-in situation to the neighboring vehicles through the V2V communication device 17 when the intention estimation unit 11 estimates that the driver intends to cut in an adjacent lane.

Of course, the V2V communication devices of the neighboring vehicles receiving the information transmitted from the V2V communication device 17 may be connected to at least one, or more, of various information devices such as a display device, a lamp, a buzzer, a voice guide device, and the like to deliver the received information to the drivers so that the received information may be communicated to the drivers.

Accordingly, when the turn signal 13 blinks in the vehicle of the driver who intends to cut in and the information on the cut-in intention is communicated to the neighboring vehicle through the V2V communication device 17, the neighboring vehicles may recognize the cut-in intention and may more effectively prepare for the cut-in of the vehicle, so that the possibility of an accident is reduced.

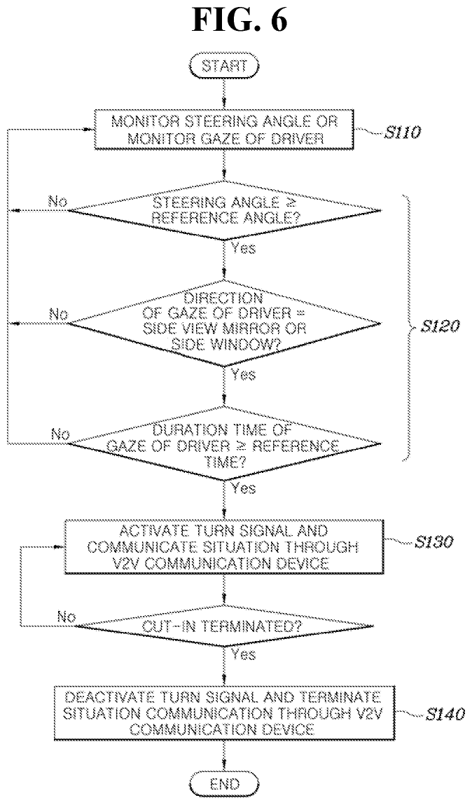

FIG. 6 is a flowchart illustrating a second embodiment of the vehicle control method for using recognition of the state of a driver according to the present invention. The second embodiment of the vehicle control method includes monitoring the steering angle of the vehicle steering wheel and the gaze of the driver (S110); estimating an intention of the driver to cut in an adjacent lane based on the steering angle and the gaze of the driver (S120); warning neighboring vehicles by communicating the information on the cut-in intention when it is determined that the driver intends to cut in an adjacent lane (S130); and terminating the warning to the neighboring vehicles when the cut-in situation is terminated.

When the steering angle increases to or beyond the reference angle from the neutral state, it may be determined that the driver intends to cut in an adjacent lane.

When the time in which the gaze of the driver remains directed toward the side-view mirror or the side window is equal to or greater than the reference time, it may be determined that the driver intends to cut in an adjacent lane.

Further, when the steering angle increases to or beyond a predetermined reference angle and the time in which the gaze of the driver remains directed toward the side-view mirror or the side window is equal to or greater than a predetermined reference time, it may be determined that the driver intends to cut in an adjacent lane.

When it is determined that the driver intends to cut in an adjacent lane, the information on the cut-in intention may be communicated to the neighboring vehicles by activating the turn signal 13 of the vehicle.

Further, when it is determined that the driver intends to cut in an adjacent lane, the information on the cut-in intention may be communicated to the neighboring vehicles through the V2V transmission device 17 mounted in the vehicle, so that the neighboring vehicles may prepare in advance

The specific embodiments of the present invention are illustrated and described, but it will be self-evident to those skilled in the art that the present invention may be improved upon and modified in various ways within the scope not departing from the technical spirit of the present invention provided by the patent claims below.

What is claimed is:

1. A system for operating a vehicle, comprising:
a processor; and
a computer-readable medium in communication with the processor and storing instructions that, when executed by the processor, cause the processor to control the system to perform:
detecting a steering angle of a vehicle and a gaze direction of a driver of the vehicle while the vehicle is traveling on a first road;
determining that a vehicle is at an exit preparation area where a preparation is needed for the vehicle to exit from the first road to a second road branching from the first road;
in response to determining that the vehicle is at the exit preparation area, determining whether a lane change is needed for the vehicle to exit from the first road to the second road;
determining whether a turn signal of the vehicle is activated for the lane change;
in response to determining that the turn signal of the vehicle is not activated, determining whether the driver intends to perform the lane change based on the detected steering angle and driver's gaze direction; and
in response to determining that the driver intends to perform the lane change, activating the turn signal.

2. The system of claim 1, wherein, for determining that the vehicle is at the exit preparation area, the instructions, when executed by the processor, further cause the processor to control the system to perform determining that a distance between (1) a first position at which the vehicle is located on the first road and (2) a second position at which the second road starts branching from the first road is within a predetermined distance.

3. The system of claim 1, wherein, for determining whether the driver intends to perform the lane change, the instructions, when executed by the processor, further cause the processor to control the system to perform:
determining whether the detected steering angle meets a predetermined angle condition; and
determining whether a duration of the detected driver's gaze direction remaining directed toward a side-view mirror or side window of the vehicle meets a predetermined duration condition.

4. The system of claim 1, wherein the instructions, when executed by the processor, further cause the processor to control the system to perform transmitting, via a V2V communication channel to a nearby vehicle, a message including the driver's intention to perform the lane change.

5. The system of claim 1, wherein the instructions, when executed by the processor, further cause the processor to control the system to perform transmitting, via a V2X communication channel to a nearby vehicle, a message including the driver's intention to perform the lane change.

6. A method of operating a vehicle, comprising:
detecting a steering angle of the vehicle and a gaze direction of a driver of the vehicle while the vehicle is traveling on a first road;
determining that a vehicle is at an exit preparation area where a preparation is needed for the vehicle to exit from the first road to a second road branching from the first road;
in response to determining that the vehicle is at the exit preparation area, determining whether a lane change is needed for the vehicle to exit from the first road to the second road;
determining whether a turn signal of the vehicle is activated for the lane change;
in response to determining that the turn signal of the vehicle is not activated, determining whether the driver intends to perform the lane change based on the detected steering angle and driver's gaze direction; and
in response to determining that the driver intends to perform the lane change, activating the turn signal.

7. The method of claim 6, wherein determining that the vehicle is at the exit preparation area comprises detecting that a distance between (1) a first position at which the vehicle is located on the first road and (2) a second position at which the second road starts branching from the first road is within a predetermined distance.

8. The method of claim 6, wherein determining whether the driver intends to perform the lane change comprises:
detecting whether the detected steering angle meets a predetermined angle condition; and
detecting whether a duration of the detected driver's gaze direction remaining directed toward a side-view mirror or side window of the vehicle meets a predetermined duration condition.

9. The method of claim 6, further comprising transmitting, via a V2V communication channel to a nearby vehicle, a message including the driver's intention to perform the lane change.

10. The method of claim 6, further comprising transmitting, via a V2X communication channel to a nearby vehicle, a message including the driver's intention to perform the lane change.

11. A system for operating a vehicle, comprising:
a camera positioned at a vehicle and configured to detect a gaze direction of a driver of the vehicle;
a steering angle sensor configured to sense a steering angle of the vehicle;
a determination unit configured to determine whether the driver intends to perform a lane change based on the detected driver's gaze direction and steering angle; and
a communication unit configured to communicate the driver's intention to perform the lane change in response to the determination unit determining that the driver intends to perform the lane change.

12. The system of claim 11, wherein the determine unit is configured to determine that the driver intends to perform the lane change when (1) the detected steering angle meets a predetermined angle condition, and (2) a duration of the driver's gaze direction remaining directed toward a side-view mirror or side window of the vehicle meets a predetermined duration condition.

13. The system of claim 11, wherein the communication tool includes a turn signal of the vehicle.

14. The system of claim 11, wherein the communication tool includes a V2V communication device configured to transmit, via a V2V communication channel to a nearby vehicle, a message including the driver's intention to perform the lane change.

15. The system of claim 11, wherein the communication tool includes a V2X communication device configured to transmit, via a V2X communication channel to a nearby vehicle, a message including the driver's intention to perform the lane change.
